(19) United States
(12) Patent Application Publication
(10) Pub. No.: US 2015/0183117 A1
(43) Pub. Date: Jul. 2, 2015

(54) OBJECT CONVEYANCE SYSTEM INCLUDING RETRACTING DEVICE

(71) Applicant: FANUC Corporation, Yamanashi (JP)

(72) Inventor: Masaru ODA, Yamanashi (JP)

(21) Appl. No.: 14/583,069

(22) Filed: Dec. 24, 2014

(30) Foreign Application Priority Data
Dec. 27, 2013 (JP) 2013-273494

(51) Int. Cl. B25J 15/08

(52) U.S. Cl. CPC B25J 15/08

(57) ABSTRACT

An object conveyance system includes a robot disposed outside a dangerous area, and an object gripping mechanism unit fitted to a leading end of the robot and configured to enter into the dangerous area. The object gripping mechanism unit is configured to take out an object present inside the dangerous area to an outside of the dangerous area, and set the object present outside the dangerous area inside the dangerous area. The object conveyance system further includes a retracting device configured to retract the object gripping mechanism unit at least partially present inside the dangerous area to the outside of the dangerous area.

### BACKGROUND OF THE INVENTION

1. Field of the Invention

The present invention relates to an object conveyance system that takes out or sets an object in a dangerous area such as a high-temperature environment area.

2. Description of the Related Art

Workpiece conveyance by using an object gripping mechanism unit, such as a servo hand, of a robot is common. A servo motor of such an object gripping mechanism unit is disposed near a claw part of the object gripping mechanism unit in many cases. An inside of a specific processing machine such as a press machine, a forging machine, or a high-temperature furnace is a high-temperature environment area where temperature is high. A workpiece processed in the high-temperature environment area is at high temperature. When such a high-temperature workpiece is taken out by the object gripping mechanism unit of the robot, there is a possibility that the servo motor may be damaged by heating the workpiece. As a result, a life of the servo motor may be considerably reduced.

Japanese Laid-open Patent Publication No. 2012-218084 discloses an object gripping mechanism unit of a dual shaft structure that includes a first shaft having a first claw part and a second shaft having a second claw part and relatively rotatable in the first shaft. In such a case, a servo motor is separated from the first claw part and the second claw part by distances corresponding to lengths of the first shaft and the second shaft. Thus, even when a workpiece is at high temperature due to heat in a high-temperature environment area, the servo motor may be prevented from being affected by the heat.

However, the object gripping mechanism unit of the robot operated in the high-temperature environment area may stop in the high-temperature environment area due to an unexpected occurrence. In such a case, there is a possibility that the object gripping mechanism unit and related members thereof, for example, the servo motor, may be damaged by heat. Further, when such a state continues for a long time, even a robot body may fail.

The present invention has been made in view of above-described circumstances, and has an object to provide an object conveyance system capable of preventing an object gripping mechanism unit or the like from being damaged even when the object gripping mechanism unit stops in a high-temperature environment area due to an unexpected occurrence.

### SUMMARY OF THE INVENTION

To achieve the object, according to a first aspect of the present invention, there is provided an object conveyance system that includes a robot disposed outside a dangerous area; an object gripping mechanism unit fitted to a leading end of the robot and configured to enter into the dangerous area, the object gripping mechanism unit being configured to take out an object present inside the dangerous area to the outside of the dangerous area, and to set the object present outside the dangerous area, inside the dangerous area; and a retracting device configured to retract the object gripping mechanism unit at least partially present inside the dangerous area to an outside of the dangerous area.

According to a second aspect of the present invention, in the object conveyance system of the first aspect, the retracting device includes a sliding unit on which the robot is mounted, a guiding unit configured to guide the sliding unit in a direction away from the dangerous area, and fixing mechanism units configured to temporarily fix the sliding unit at a predetermined position of the guiding unit.

According to a third aspect of the present invention, in the object conveyance system of the first or second aspect, the dangerous area is a high-temperature environment area.

### BRIEF DESCRIPTION OF THE DRAWINGS

The above objects, features, and advantages, and other objects, features, and advantages of the present invention will become more apparent from the following detailed description of the exemplary embodiments of the present invention taken in connection with the accompanying drawings, in which:

FIG. 1 is a perspective view of an object conveyance system according to the present invention;

FIG. 2 is a perspective view during an operation of a robot illustrated in FIG. 1; and

FIG. 3 is a perspective view at the time of retraction of the robot illustrated in FIG. 1.

### DETAILED DESCRIPTION

Hereinafter, the embodiment of the present invention will be described with reference to the accompanying drawings. In the drawings below, the same or similar members are denoted by the same reference numerals. For facilitating easier understanding, scales have been appropriately changed in the drawings.

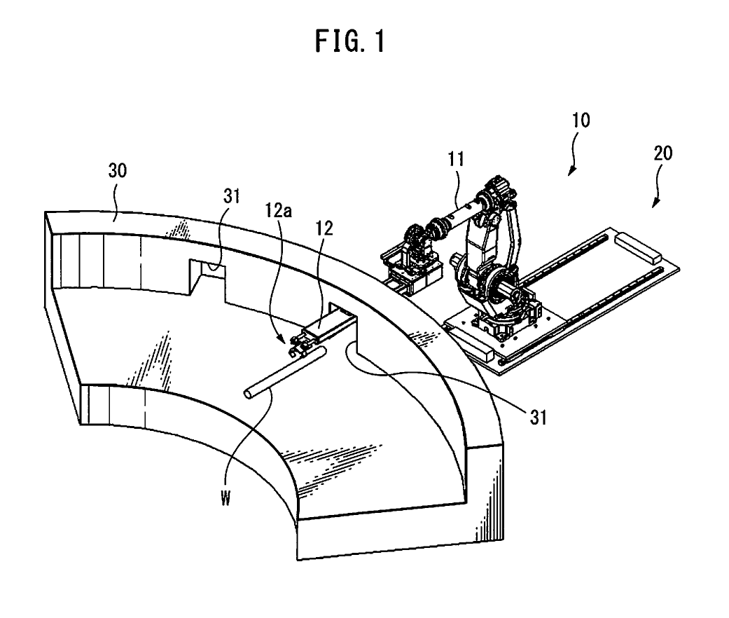

FIG. 1 is a perspective view illustrating an object conveyance system according to the present invention. The object conveyance system 10 illustrated in FIG. 1 includes a robot 11, and an object gripping mechanism unit 12 fitted to a leading end of the robot 11. The robot 11 illustrated in FIG. 1 is a six-axis articulated robot. However, robots of other types may be employed. As illustrated, a pair of opening/closing part 12a for gripping a workpiece W is disposed at a leading end of the object gripping mechanism unit 12.

FIG. 1 illustrates a high-temperature furnace 30 in which a plurality of openings 31 are formed. An inside of the high-temperature furnace 30 is a dangerous area, a high-temperature environment area in this case, in which the workpiece W is processed at a high temperature. As can be seen from FIG. 1, the robot 11 is installed outside the high-temperature environment area, and the outside of the high-temperature environment area is not a dangerous area. The object gripping mechanism unit 12 is a long member sufficiently long to enter into the high-temperature furnace 30 through the opening 31. The object gripping mechanism unit 12 closes the opening/closing part 12a in the high-temperature furnace 30 to grip the workpiece W, and conveys the workpiece W to the outside of the high-temperature furnace 30 through the opening 31. The object gripping mechanism unit 12 passes the workpiece W gripped by using the opening/closing part 12a through the opening 31, and releases the workpiece W at a predetermined position in the high-temperature furnace 30 to set it. Accordingly, the object gripping mechanism unit 12 of the robot 11 reciprocates between the inside and the outside of the high-temperature environment area.

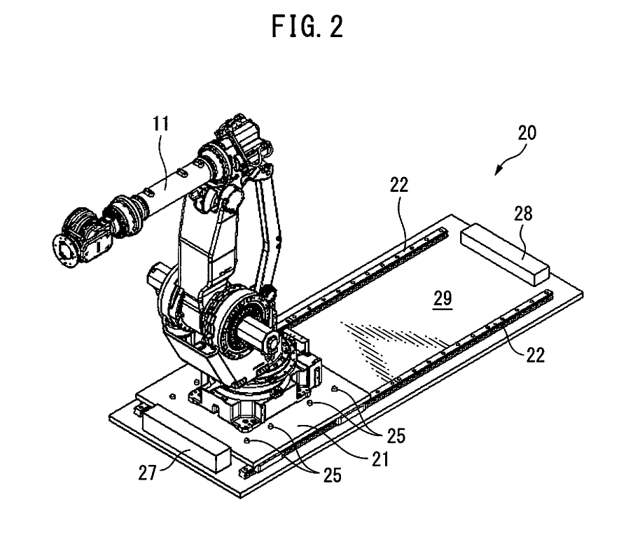

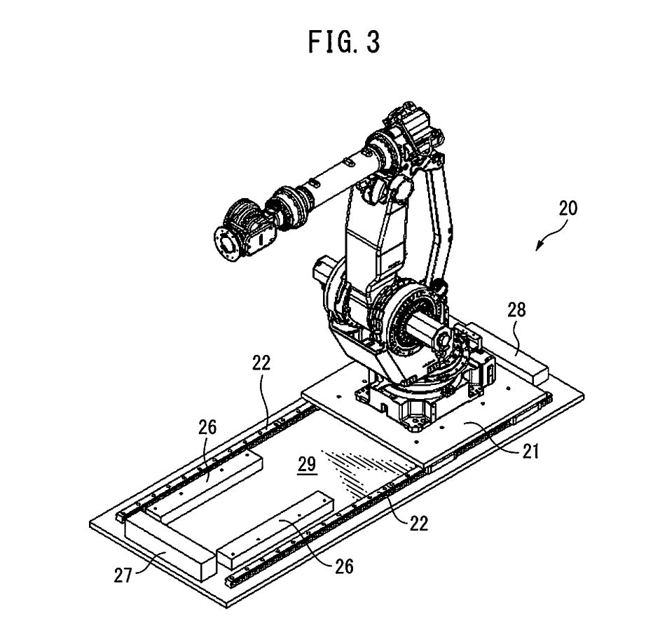

FIG. 2 is a perspective view during an operation of the robot illustrated in FIG. 1. In FIG. 2 and FIG. 3 described below, for simplicity, the object gripping mechanism unit 12 is not illustrated. As illustrated in

FIG. 2, the robot 11 is disposed on a retracting device 20. The retracting device 20 includes a base plate 29, and two guide rails 22 extending in parallel to each other on the base plate 29.

As can be seen with reference to FIG. 1, the guide rails 22 extend in a direction away from the high-temperature furnace 30. For example, when an outer peripheral part of the high-temperature furnace 30 is circular, the guide rails 22 preferably extend outward in a radial direction of the high-temperature furnace 30. When the outer peripheral part of the high-temperature furnace 30 is planar, the guide rails 22 preferably extend perpendicularly to the outer peripheral part of the high-temperature furnace 30. Alternatively, the guide rails 22 may include at least a direction component away from the high-temperature furnace 30.

As illustrated in FIG. 2, a slider 21 is disposed to be slidable on the guide rails 22. A base part of the robot 11 is fixed to a top surface of the slider 21. A front side stopper 27 is fitted to one end of the base plate 29 adjacent to the high-temperature furnace 30 (not illustrated in FIG. 2), and a rear side stopper 28 is fitted to the other end of the base plate 29. The slider 21 slides on the guide rails 22 between the front side stopper 27 and the rear side stopper 28. In FIG. 2, the slider 21 is at a position adjacent to the front side stopper 27 fitted to one end of the base plate 29.

FIG. 3 is a perspective view at the time of retraction of the robot illustrated in FIG. 1. As can be seen from comparison of FIG. 3 with FIG. 2, a pair of fixing blocks 26 is present below the slider 21 located at the position adjacent to the front side stopper 27.

Each of the fixing blocks 26 is fixed to the base plate 29 along an inner wall of the guide rail 22. As can be seen from FIG. 2, the slider 21 is fixed to the fixing blocks 26 by a plurality of fixing bolts 25 during an operation.

When conveying the workpiece W using the object conveyance system 10 according to the present invention, as illustrated in FIG. 2, the slider 21 is fixed at the position adjacent to the front side stopper 27. This position is suitable for conveying the workpiece W to/from the high-temperature furnace 30 by the robot 11 of the object conveyance system 10. As illustrated in FIG. 1, the robot 11 performs the aforementioned operation by using the object gripping mechanism unit 12. In other words, the object gripping mechanism unit 12 of the robot 11 feeds the workpiece W into the high-temperature furnace 30, and conveys the high-temperature workpiece W processed in the high-temperature furnace 30 to the outside of the high-temperature furnace 30.

In a state where the object gripping mechanism unit 12 is at least partially present in the high-temperature furnace 30, the robot 11 may stop due to an unexpected occurrence, for example, a blackout. In such a case, all of the fixing bolts 25 are manually removed to slide the slider 21 along the guide rails 22 to the vicinity of the rear side stopper 28.

Lengths of the guide rails 22 are set so that a movable distance of the slider 21 can be longer than the object gripping mechanism unit 12. In such a case, even when the entire object gripping mechanism unit 12 enters the high-temperature furnace 30, the entire object gripping mechanism unit 12 can be retracted to the outside of the high-temperature furnace 30 by sliding the slider 21 to the rear side stopper 28.

Thus, according to the present invention, when the robot 11 stops in the high-temperature furnace 30 due to the unexpected occurrence, the object gripping mechanism unit 12 is urgently retracted to the outside of the high-temperature furnace 30 by using the retracting device 20. As a result, the object gripping mechanism unit 12, a servo motor that operates the object gripping mechanism unit 12, or the like can be prevented from being damaged by heat from the high-temperature furnace 30.

According to the present invention, simply by releasing the fixing bolts 25, the entire robot 11 on the slider 21 can be moved along the guide rails 22 together with the object gripping mechanism unit 12. As a result, the robot 11 and the object gripping mechanism unit 12 are easily reliably retracted to the outside of the high-temperature furnace 30. The slider 21 may be fixed to the vicinity of the front side stopper 27 by fixing mechanism units such as fixing clips other than the fixing bolts 25. In the event of an unexpected occurrence, the slider 21 can be automatically slid by releasing the fixing mechanism units.

The embodiment has been described with reference to the drawings supposing that the retracting device 20 retracts the object gripping mechanism unit 12 from the inside of the high-temperature furnace 30 that is the high-temperature dangerous area. However, not only the inside of the high-temperature furnace 30 but also the inside of a press machine or a forging machine are high-temperature dangerous areas. Even in such environments, the object conveyance system 10 according to the present invention can be used. As obvious to those skilled in the art, the object conveyance system 10 according to the present invention can be similarly used even in dangerous areas other than the high-temperature area, for example, an environment where chemicals are scattered.

### EFFECTS OF THE INVENTION

According to a first aspect, when the robot stops in the dangerous area due to an unexpected occurrence, the object gripping mechanism unit can be retracted to the outside of the dangerous area by using the retracting device. As a result, the object gripping mechanism unit and related members thereof such as the servo motor can be prevented from being damaged.

According to a second aspect, the robot and the object gripping mechanism unit are easily reliably retracted to the outside of the dangerous area by releasing temporary fixing set by the fixing mechanism units and moving the entire robot on the sliding unit along the guiding units. The fixing mechanism units are preferably, for example, fixing bolts.

According to a third aspect, the object gripping mechanism unit and the related members thereof can be prevented from being damaged by heat of the high-temperature environment area.

While the exemplary embodiment has been described, as obvious to those skilled in the art, the aforementioned changes, various other changes, omissions, and additions can be made without departing from the scope of the present invention.

What is claimed is:

1. An object conveyance system comprising:
a robot disposed outside a dangerous area;
an object gripping mechanism unit fitted to a leading end of the robot and configured to enter into the dangerous area,
the object gripping mechanism unit being configured to take out an object present inside the dangerous area to the outside of the dangerous area, and to set the object present outside the dangerous area, inside the dangerous area; and
a retracting device configured to retract the object gripping mechanism unit at least partially present inside the dangerous area to an outside of the dangerous area.

2. The object conveyance system according to claim 1, wherein the retracting device includes:
a sliding unit on which the robot is mounted;
a guiding unit configured to guide the sliding unit in a direction away from the dangerous area; and
fixing mechanism units configured to temporarily fix the sliding unit at a predetermined position of the guiding unit.

3. The object conveyance system according to claim 1, wherein the dangerous area is a high-temperature environment area.

4. The object conveyance system according to claim 2, wherein the dangerous area is a high-temperature environment area.
